(19) United States
(12) Patent Application Publication
(10) Pub. No.: US 2009/0112869 A1
(43) Pub. Date: Apr. 30, 2009

(54) SOLUTION THAT UTILIZES ACCESS QUEUES FOR AUTOMATICALLY MANAGING ACCESS TO AN ELECTRONIC DOCUMENT

(75) Inventors: JOEL DUQUENE, RALEIGH, NC (US); HENRI F. MELI, CARY, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/927,022

(22) Filed: Oct. 29, 2007

(51) Int. Cl. G06F 17/30

(52) U.S. Cl. 707/9; 707/E17.008

(57) ABSTRACT

The present invention discloses a system for automatically controlling access to electronic documents. Such a system can include a set of electronic documents, a set of access queues, and a document access manager. Each access queue in the set of access queues can be configured to store a waiting list of reviewers for a specific electronic document. The document access manager can be configured to automatically add access requests for an electronic document to the corresponding access queue when the electronic document is currently being accessed. Additionally, the document access manager can automatically transfer access of the electronic document to the next reviewer in the access queue when the electronic document becomes available.

### BACKGROUND

1. Field of the Invention

The present invention relates to the field of electronic document management and, more particularly, to automatically managing access to electronic documents using access queues.

2. Description of the Related Art

Businesses continue to strive to become paperless and leverage the benefits of electronic documentation. Document management systems have been key elements for centralizing storage and access to electronic documents. These management systems generally function like an electronic librarian; allowing users to check-out, check-in, and search for electronic documents.

A major drawback to such systems is their inability to handle the demand of a specific electronic document by multiple users. Take, for example, the scenario where Reviewer A has checked out Document A. When Reviewer B attempts to access Document A, Reviewer B is told that Document A is currently checked out. Now Reviewer B must check the system frequently to determine if Document A has become available. In this scenario, it is possible for Reviewer A to check-in Document A and for Reviewer C to check it out before Reviewer B checks for availability. Therefore, increasing Reviewer B's frustration with the system and decreasing their productivity and ability to complete their assignment.

What is needed is a solution that automatically queues and transfers access among multiple requesters for an electronic document. That is, when an electronic document is being accessed, subsequent access requests can be captured in an access queue so they can be addressed in order. Ideally, this solution would notify the members of the access queue as to an estimated time when they will be able to access the document as well as any changes in the availability of the document.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for using access queues to automatically manage access to electronic documents in accordance with embodiments of the inventive arrangements disclosed herein.

FIG. 2 is a visual representation of an example access queue in accordance with an embodiment of the inventive arrangements disclosed herein.

FIG. 3 is a flow chart of a method for utilizing access queues to automatically control access to electronic documents in accordance with an embodiment of the inventive arrangements disclosed herein.

### DETAILED DESCRIPTION OF THE INVENTION

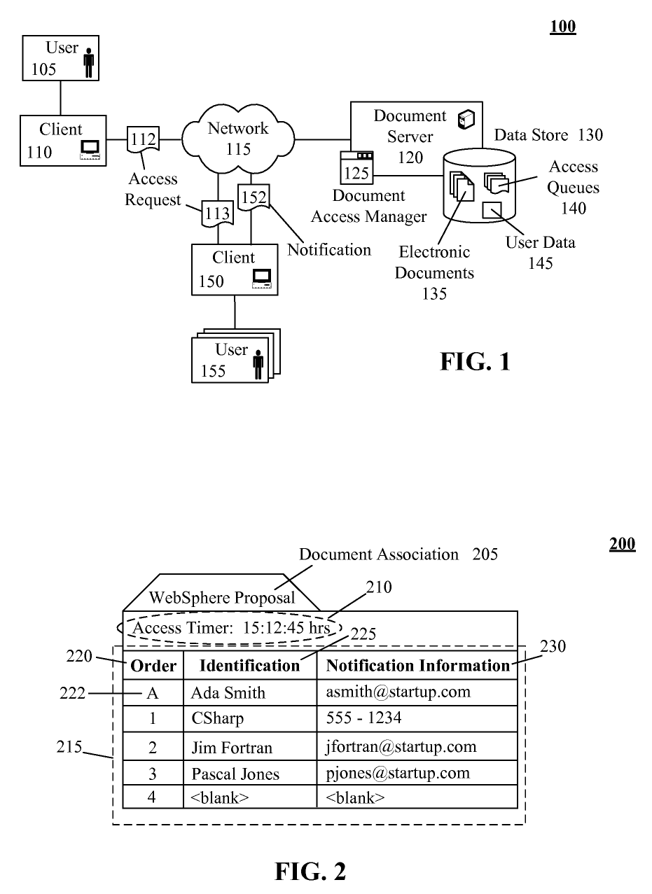

FIG. 1 is a schematic diagram illustrating a system 100 for using access queues 140 to automatically manage access to electronic documents 135 in accordance with embodiments of the inventive arrangements disclosed herein. The document access manager 125 of system 100 can automatically manage access to a set of electronic documents 135 for multiple users 105 and 155.

In system 100, user 105 can use a client 110 to send an access request 112 for an electronic document 135 over the network 115 to the document server 120. The client 110 can represent a variety of communication devices, including, but not limited to, a personal computer, a personal data assistant (PDA), a mobile phone, a smart phone, a kiosk, a laptop, and the like.

The access request 112 can be an electronic message generated by the client 110 using standard communication protocols supported by the document server 120. The access request 112 can contain information that identifies the user 105 to the document server 120. For example, the document server 120 can check the contents of the access request 112 against a set of user data 145 for a match.

The document server 120 can be a computing device configured to provide users 105 and 155 with access to a multitude of electronic documents 135. The document server 120 can include a document access manager 125 and a data store 130. The document access manager 125 can be a software component running on the document server 120 that controls access to the electronic documents.

Of particular note is the situation where additional users 155 request access to a document 135 when the document 135 is already being accessed by another user 105. In this situation, the document access manager 125 can capture information regarding the additional access request 113 in an access queue 140 that is associated with the specific electronic document 135.

An access queue 140 can be a data structure that stores information about access requests 112 and 113 for the data access manager 125. The information stored in an access queue 140 can include information that identifies the requesting user 155 as well as contact information. Such information can be obtained from the access request 113 and/or a set of user data 145.

The access queue 140 can utilize a timer function to ensure a timely flow of access. For example, predetermined values can be defined for the amount of time a user 105 is initially given to access a document 135, the maximum time a user 105 is allowed, and/or the time increment that a user 105 can extend their initial access time.

When the document access manager 125 receives an access request 113 from a user 155 after already allowing another user 105 access to a document 135, the document access manager 125 can document the request 113 in the access queue 140 associated with the electronic document 135. The document access manager 125 can then send the user 155 a notification 152 stating that the specific document 135 is unavailable. The notification 152 can further include a projected time when the user 155 will be given access to the electronic document 135.

When access to the electronic document 135 is relinquished by user 105 or the user 105 exceeds their allotted time, the document access manager 125 can automatically give the next user 155 in the access queue 140 access to the document 135. The document access manager 125 can send the user 155 a notification 152 again, which indicates that they now have access to the document 135.

It is important to stress the automatic and dynamic nature of this system 100 in contrast to conventional implementations. In this system 100, user 155 is guaranteed access to the electronic document 135 in an order dictated by the receipt of their access request 113. User 155 can receive automatic updates when changes occur to the access queue 140 and can schedule other tasks around the projected time when they will receive access to the document 135.

As used herein, presented data stores, including store 130, can be a physical or virtual storage space configured to store digital information. Data store 130 can be physically implemented within any type of hardware including, but not limited to, a magnetic disk, an optical disk, a semiconductor memory, a digitally encoded plastic memory, a holographic memory, or any other recording medium. The data store 130 can be a stand-alone storage unit as well as a storage unit formed from a plurality of physical devices. Additionally, information can be stored within data store 130 in a variety of manners. For example, information can be stored within a database structure or can be stored within one or more files of a file storage system, where each file may or may not be indexed for information searching purposes. Further, data store 130 can utilize one or more encryption mechanisms to protect stored information from unauthorized access.

Network 115 can include any hardware/software/and firmware necessary to convey data encoded within carrier waves. Data can be contained within analog or digital signals and conveyed though data or voice channels. Network 115 can include local components and data pathways necessary for communications to be exchanged among computing device components and between integrated device components and peripheral devices. Network 115 can also include network equipment, such as routers, data lines, hubs, and intermediary servers which together form a data network, such as the Internet. Network 115 can also include circuit-based communication components and mobile communication components, such as telephony switches, modems, cellular communication towers, and the like. Network 115 can include line based and/or wireless communication pathways.

FIG. 2 is a visual representation of an example access queue 200 in accordance with an embodiment of the inventive arrangements disclosed herein. The access queue 200 can be utilized in system 100 by the document access manager 125 to automatically control access to electronic documents 135. It should be noted that the contents of the example access queue 200 are for illustration purposes only and are not meant as an absolute implementation of the present invention.

The access queue 200 can include document association information 205 that associates it with a specific electronic document, an access timer 210, and a waiting list 215 that identifies users who are waiting to access the electronic document. In this example, the document name is used as the document association information 205.

It should be noted that the document association information 205 should be a unique identifier to provide a distinct one-to-one relationship between an electronic document and an access queue 200. Therefore, care should be taken to account for multiple versions of a document as well as different document formats that can all have the same document name.

The waiting list 215 can include a variety of information that can allow the system, such as system 100, to notify listed users of changes to the queue 200 and to automatically provide the listed users access to the electronic document. In this example, the waiting list 215 includes an order identifier 220, user identification 225, and notification information 230.

The order identifier 220 can be a ranking system that indicates the order in which users are to access the electronic document. The order identifier 220 can include a unique identifier 222 for designating the user that currently possesses access privileges to the electronic document, herein referred to as the active user. In this example, the active user is designated by an ‘A’ identifier 222 and additional users are sequentially numbered.

User identification 225 information can identify a user that is associated with an access request. The user identification 225 can be obtained from the associated access request and/or a repository of user information for the system, such as the user data 145 of system 100. User identification 225 information can be a variety of items, such as the user name used in this example.

Notification information 230 can indicate the means to notify the user with changes to the access queue 200. Similar to user identification 225, notification information 230 can also be obtained from the associated access request and/or a repository of user information for the system. Notification information 230 can capture a variety of items, such as the email addresses and phone numbers shown in this example.

It is important to note that the notification information 230 captured and/or utilized needs to be supported by the overall system. For example, phone numbers should only be used as notification information 230 if the system has the ability to place phone calls.

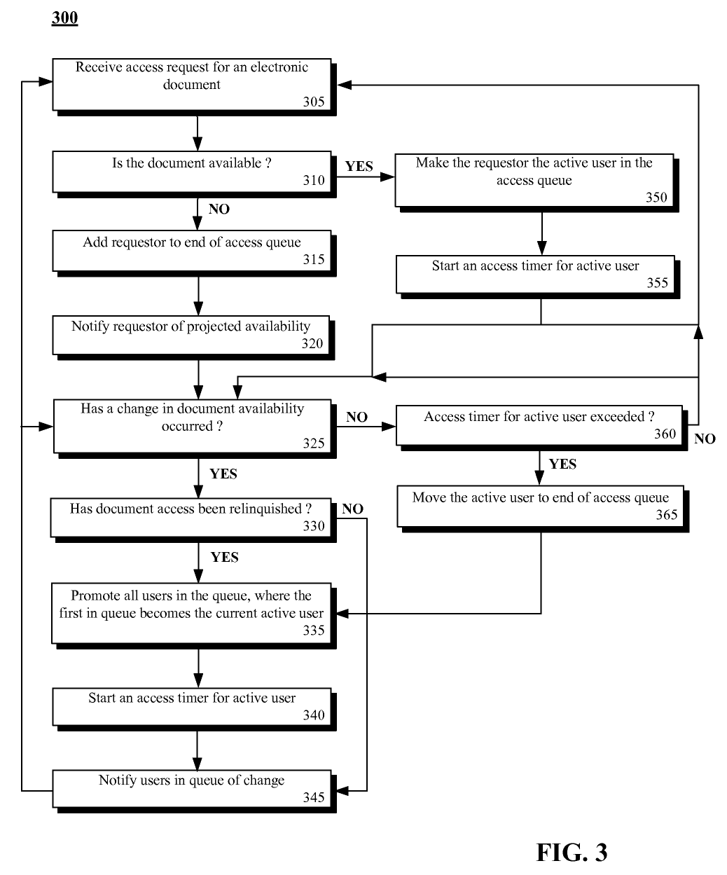

FIG. 3 is a flow chart of a method 300 for utilizing access queues to automatically control access to electronic documents in accordance with an embodiment of the inventive arrangements disclosed herein. Method 300 can be performed in the context of system 100 and/or utilize the example access queue 200 of FIG. 2.

It should be appreciated that the steps of method 300 illustrate handling the access of a single electronic document. This is for simplicity and should not be construed as a limitation of the present invention. The steps of method 300 can be executed concurrently for multiple electronic documents.

Method 300 can begin with step 305 where an access request for an electronic document can be received. In step 310, the system can determine if the document is available. When the document is available, flow can divert to step 350 where the requester can be added to the corresponding access queue as the active user. In step 355, an access timer can be started for the active user.

After the execution of step 355, either step 305 or step 325 can execute, depending on the events encountered by the system. That is, the system awaits receipt of either another access request or a change in availability of the document to determine which point in the method 300 to execute.

When a requested document is unavailable, step 315 can execute in which the requester can be added to the end of the corresponding access queue. In step 320, the requester can then be sent a notification containing a projected availability time. The system can determine if a change in document availability has occurred in step 325.

If no change in availability has been determined, step 360 can execute where the access timer for the active user can be checked. When the access timer is not exceeded, the system can await to execute either step 305 or 325. When the access timer is exceeded, flow can proceed to step 365 where the active user can be moved to the end of the access queue.

If a change in availability is determined in step 325, step 330 can execute where it can be determined if the active user has relinquished access to the document. When access has been relinquished, all the users in the access queue can be promoted in step 335. The promotion conducted in step 335 can cause the first user in the queue to become the current active user, effectively replacing the previous active user. Execution of step 335 can also be triggered by step 365.

An access timer can be started for the active user in step 340. In step 345, the system can notify the users in the access queue of the change in access. Once step 345 executes, the system can await to execute either step 305 or 325.

Execution of step 345 can also be triggered when the system determines that the document has not been relinquished in step 330. An example of a change in document availability that does not involve the active user relinquishing access can be the active user extending their access time.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for automatically controlling access to electronic documents comprising:
a set of electronic documents;
a set of access queues configured to store a waiting list of users for document access, wherein a one-to-one relationship exists between members of the set of electronic documents and the set of access queues; and
a document access manager configured to automatically add access requests for an electronic document to its corresponding access queue when the electronic document is currently being accessed, and to automatically transfer access of the electronic document to a subsequent access request contained in the access queue when the electronic document becomes available.

2. The system of claim 1, wherein the document access manager sends notifications to members of the waiting list when a change in accessibility for the electronic document occurs.

3. The system of claim 2, wherein the notifications include a projected time when a member of the waiting list is able to access the electronic document.

4. The system of claim 2, wherein a notification is at least one of an email message, a text message, an instant message, a pager message, and a voice mail message.

5. The system of claim 1, wherein the waiting list includes identification information, notification information, and an order identifier for each member.

6. The system of claim 5, wherein the identification information and notification information is automatically obtained from a set of user data, wherein the set of user data is a component of a document management system.

7. The system of claim 1, further comprising:
a data store configured to contain the set of electronic documents and the set of access queues; and
a document server configured to run the document access manager and provide access to the set of electronic documents.

8. The system of claim 1, wherein within an access queue a user currently accessing the electronic document is uniquely designated as an active user.

9. The system of claim 8, wherein the active user is allotted a predetermined amount of time to access the electronic document, wherein the document access manager tracks said predetermined amount of time with an access timer.

10. The system of claim 9, wherein failure to relinquish access to the electronic document before an end of the predetermined amount of time by the active user causes the document access manager to automatically terminate access of the active user and transfer access to a subsequent member of the waiting list, wherein the subsequent member becomes the active user and the terminated active user is placed at an end of the waiting list.

11. A method for controlling access to an electronic document comprising:
identifying an electronic document that is to be accessed by a plurality of users, wherein access to the electronic document is restricted to one user at a time;
establishing an access queue for accessing the electronic document, wherein said access queue comprises a sequential ordering for when at least two of said users are to be granted access to the electronic document, wherein said granted access is time restricted, wherein said time restriction is indicated for the access queue; and
sequentially granting access to said electronic document to said at least two users in accordance with an order specified within the access queue.

12. The method of claim 11, further comprising:
presenting the indicated time restriction to the at least two users so that each of the users are aware of when and for how long that user is able to access the electronic document.

13. The method of claim 11, further comprising:
receiving requests from said at least two users to access said electronic document; and
wherein responsive to each request, an entry for the requesting user is added to said access queue.

14. The method of claim 11, further comprising:
a currently active user having access to the electronic document relinquishing access the electronic document to a document management system so that other users are able to access the returned electronic document;
wherein the currently active user is a topmost user of the access queue;
removing the currently active user from the access queue; and
upwardly adjusting other users within the access queue by one incremental position.

15. The method of claim 14, further comprising:
when a currently active user having access to the electronic document fails to voluntarily relinquish access to the electronic document before the time restriction for access expires;
revoking access to the currently active user;
removing the currently active user from a topmost position in the access queue; and
upwardly adjusting other users within the access queue by one incremental position, which grants a new user who is now at a topmost position in the access queue access to the electronic document.

16. The method of claim 11, wherein said steps of claim 11 are performed by at least one machine in accordance with at least one computer program stored in a computer readable media, said computer programming having a plurality of code sections that are executable by the at least one machine.

17. An electronic document management system comprising:
a data store containing user data, a set of electronic documents, and a set of access queues, wherein a one-to-one relationship exists between members of the set of electronic documents and the set of access queues;
a document access manager configured to automatically add access requests for an electronic document to its corresponding access queue when the electronic document is currently being accessed, and to automatically transfer access of the electronic document to a subsequent access request contained in the access queue when the electronic document becomes available
a document server configured to run the document access manager and provide access to the set of electronic documents.

18. The management system of claim 17, wherein an access queue is configured to store a waiting list of users for accessing an associated electronic document.

19. The management system of claim 17, wherein the document access manager sends notifications to members of an access queue when a change in accessibility for an associated electronic document occurs, wherein the notifications indicate a projected time when the electronic document will be accessible.

20. The management system of claim 17, wherein within an access queue a user currently accessing an associated electronic document is uniquely designated as an active user, wherein the active user is allotted a predetermined amount of time to access the electronic document, wherein the document access manager tracks said predetermined amount of time with an access timer.
